(19) United States
(12) Patent Application Publication
(10) Pub. No.: US 2007/0036167 A1
(43) Pub. Date: Feb. 15, 2007

(54) Method, device, and system, for terminating a user session in a multicast service

(76) Inventor: Lixin Hu, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/479,639

(22) Filed: Jun. 30, 2006

(30) Foreign Application Priority Data
Jun. 30, 2005 (CN) 2005 10080582.X

(51) Int. Cl. H04L 12/56

(52) U.S. Cl. 370/410; 370/390

(57) ABSTRACT

The present invention provides a method for terminating a user session in a multicast service. Specifically, the method includes: initiating a request for terminating a user session by a multicast service device, the request containing a session ID for identifying a user session to be terminated, and releasing the network resources occupied by the user session corresponding to the session ID contained in the request. This invention also provides another method for terminating a user session in a multicast service, a multicast service device, a device for terminating user sessions, and a system of multicast services. The present invention resolves the current problem that a network operator cannot exclude unpaid users from multicast services. It also avoids wasting network resources and can conduct the real time charging for prepaid users.

### FIELD OF THE TECHNOLOGY

The present invention relates to the multicast technology field, and more particularly to methods for terminating a user session in a multicast service, a multicast service device, a device for terminating user sessions, and a system of multicast services.

### BACKGROUND OF THE INVENTION

In the wireless communication field, a multicast service is a point-to-multipoint unidirectional bearer service in which data from a single source entity is transmitted to multiple recipients, i.e., a device for transmitting data is serving for multiple recipients simultaneously. In a multicast mode, transmitting the same data to multiple recipients allows network channels to be shared, thereby raising the utilization efficiency of networks. However, a unicast service is a point-to-point service, where one device for transmitting data serves just one individual receiving device.

FIG. 1 illustrates the architecture of a wireless network supporting the Multimedia Broadcast/Multicast Service (MBMS). In the existing 3GPP and 3GGP2, a Broadcast/Multicast Service Center (BM-SC) 101 is for supporting MBMS. In FIG. 1, the BM-SC 101 connects to a content provider/multicast broadcast source and it also connects to a Traffic Plane Function/Gateway General Package Radio Service Support Node (TPF/GGSN) 102 via a Gmb interface or Gi interface. One BM-SC 101 may connect to more than one TPF/GGSN 102. A TPF/GGSN 102 connects to a Serving GPRS Support Node (SGSN) 103 via a Gn/Gp interface. One TPF/GGSN 102 may connect to more than one SGSN 103. An SGSN 103 connects to a Universal Mobile Telecommunication System (UMTS) Terrestrial Access Network (UTRAN) 104 via an Iu interface. A UTRAN 104 connects to a User Equipment (UE) 106 via a Uu interface. The SGSN 103 may also connect to a GSM Enhanced Data rates for GSM Evolution (EDGE) Radio Access Network (GERAN) 105 via an Iu/Gb interface. A GERAN 105 connects to a UE 107 via a Um interface. The GGSN and SGSN are nodes in a Core Network (CN) of a wireless network.

The methods of starting and terminating a user session in the existing MBMS are as follows.

When a receiving device needs to receive multicast data, it registers at a device for transmitting multicast data. If the receiving device no longer wants to receive multicast data, it initiates a leaving process, i.e., MBMS multicast deactivation, to the device for transmitting multicast data. Once, the process of MBMS multicast deactivation is completed, the device for transmitting multicast data stops sending multicast data to the receiving device. After all the receiving devices have been deactivated, the device for transmitting multicast data stops sending multicast data.

Furthermore, in order to prevent unsubscribed or unpaid users from enjoying multicast services, in a multicast service group, each practical multicast service is assigned an MBMS Service key (MSK),which is known to only users of the group and multicast service providers, and users outside the group have no right to information of the key. The shared MSK is not for encrypting multicast data directly but for accessing control, generating an MBMS Transport Key (MTK) and encrypting the MTK. The multicast service provider uses a MTK to encrypt multicast data. Users in the corresponding group use the same shared MTK to decrypt the received multicast data so as to obtain the contents of the multicast data. Since users outside the group do not have the shared MTK, they can not obtain the multicast data's contents Also, the multicast service provider periodically sends an updated MSK to each user of a group to ensure the information security

If a user in a group wishes to stop receiving multicast data, it will send a message for MBMS multicast deactivation to the multicast service provider. Once the multicast service provider receives the message, it will stop sending MSKs. Thus, the user will no longer have the correct MSK and cannot decrypt the received multicast data, thereby realizing the object of stopping the user's receiving multicast data. Here, the multicast service provider usually refers to a device for transmitting multicast data, e.g., a BM-SC.

From the aforementioned process, it can be seen that no matter which method is adapted to terminate a user session, it is always a user who initiates the process of MBMS multicast deactivation to terminate the user session.

In addition, in the multicast mode, the network can also initiate a process of terminating user sessions. However, the process of terminating user sessions initiated by the network is for a group of users but not for a single user.

### SUMMARY

The present invention provides methods, devices and a system for terminating a user session in a multicast service. The present invention is implemented as follows.

The present invention provides a method for terminating a user session in a multicast service, including: initiating a request for terminating a user session by a multicast service device, the request containing a session ID for identifying a user session to be terminated, and releasing the network resources occupied by the user session corresponding to the session ID contained in the request.

In the above solution, before initiating the request for terminating a user session, the method may further include: for each user terminal, obtaining a termination condition for terminating the user terminal's user session, determining whether the termination condition is met, and if yes, initiating the request for terminating a user session.

In the above solution, the termination condition may be that the current service value is equal to or more than the allowable service value.

In the above solution, if the service value is the amount of the Multicast Service Keys (MSKs) sent to the user terminal, the termination condition is that the current amount of the MSKs sent to the user terminal is equal to or more than the maximum amount of the MSKs that could be sent to the user terminal; and if the service value is the duration of transmitting multicast data to the user terminal, the termination condition is that the current duration of transmitting multicast data to the user terminal is equal to or more than the maximum duration of transmitting multicast data to the user terminal.

In the above solution, if the service value is the amount of the MSKs sent to the user terminal and the allowable service value is the maximum duration of transmitting multicast data to the user terminal, the termination condition is that the current amount of the MSKs sent to the user terminal is equal to or more than the maximum amount of the MSKs converted from the maximum duration of transmitting multicast data to the user terminal.

In the above solution, the termination condition may be that the user terminal's time limit for subscribed multicast service has expired.

In the above solution, the termination condition that the user terminal's time limit for subscribed multicast service has expired may include: the amount of the MSKs sent to the user terminal is equal to or more than the maximum amount of the MSKs sent to the user terminal converted from the time limit for subscribed multicast service.

In the above solution, the termination condition may be that a message for requesting to terminate a user session from an online command system has been received.

In the above solution, the termination condition may include: the current service value being equal to or more than the allowable service value of the user terminal, the user terminal's time limit for subscribed multicast service having expired, or a message for requesting to terminate a user session of the user terminal from an Online Command System having been received; or a casual combination of the three; and wherein determining whether the termination condition is met may include: determining whether any condition included in the termination condition is met, if any of the conditions included in the termination condition has been satisfied, confirming the termination condition is met.

The present invention also provides another method for terminating a user session in multicast service, including: upon receiving a multicast service request from a user terminal, setting up a multicast transmitting channel between the user terminal and a multicast service device, and obtaining an allowable service value; sending multicast data corresponding to the multicast service request from the multicast service device to the user terminal, and obtaining a current multicast service value dynamically; and comparing the current service value with the obtained allowable service value, if the current service value is equal to or more than the allowable service value, terminating the current transmitting.

A multicast service device is provided according to the present invention, including: a unit for determining session termination conditions and a unit for initiating session termination, wherein: the unit for determining session termination conditions is for determining whether a user terminal has satisfied its termination condition for a user session, and if the termination condition for a user session has been satisfied, outputting an instruction of session termination to the unit for initiating session termination; and the unit for initiating session termination is for initiating a request for termination a user session including a session ID when receiving the instruction of session termination.

In the above solution, the multicast service device may further include: a configuration unit for receiving configuration information, for each user terminal, generating a termination condition for a user session, and configuring a termination condition for a user session to the unit for determining session termination conditions.

A device for terminating user sessions is also provided according to the present invention, including: a unit for receiving requests and a unit for terminating sessions, wherein: the unit for receiving requests is for receiving a request for terminating a user session which includes a session ID, and outputting an instruction containing the session ID to the unit for terminating sessions; and the unit for terminating sessions is for receiving the instruction from the unit for receiving requests, and releasing the occupied network resources corresponding to the session ID contained in the instruction.

This invention also provides a multicast service system which includes: a multicast service device, a device for terminating user sessions, and user terminals, wherein the multicast service device is for constructing a user session with each user terminal and transmitting multicast data to the user terminal, for each user terminal, the multicast service device is for determining whether the user terminal has satisfied its termination condition for a user session, and if the termination condition for a user session has been satisfied, sending a request for terminating a user session to the device for terminating user sessions which contains a session ID; and the device for terminating user sessions is for receiving the request for terminating a user session from the multicast service device, and releasing the occupied network resources corresponding to the session ID contained in the request.

The key of the present invention is that a multicast service device initiates a request for terminating a user session by a multicast service device, the request containing a session ID for identifying a user session to be terminated, and the network resources occupied by the user session corresponding to the session ID contained in the request is then released.

### BRIEF DESCRIPTION OF THE DRAWINGS

FIG. 1 illustrates the architecture of a wireless network supporting the MBMS.

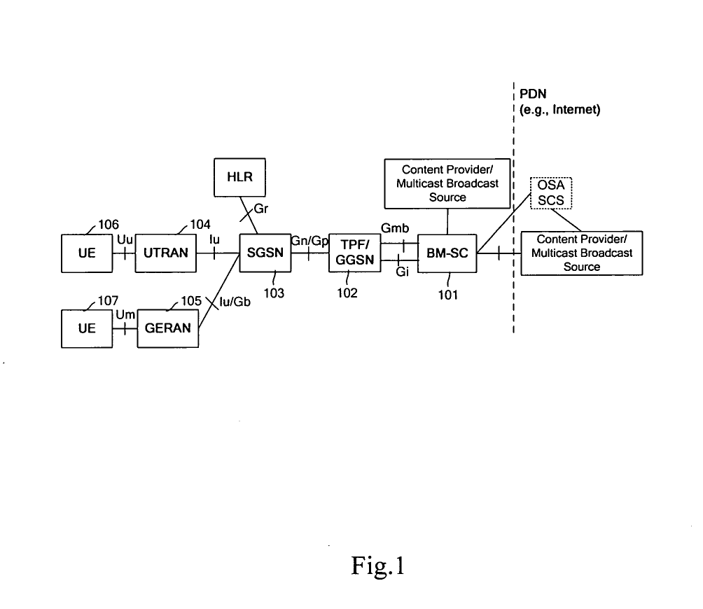

FIG. 2 illustrates a flowchart for initiating a process of terminating a user session by a BM-SC according to an embodiment of the present invention.

### EMBODIMENTS OF THE INVENTION

In reference to the figures and the exemplary embodiment, the present invention is explained in detail as follows.

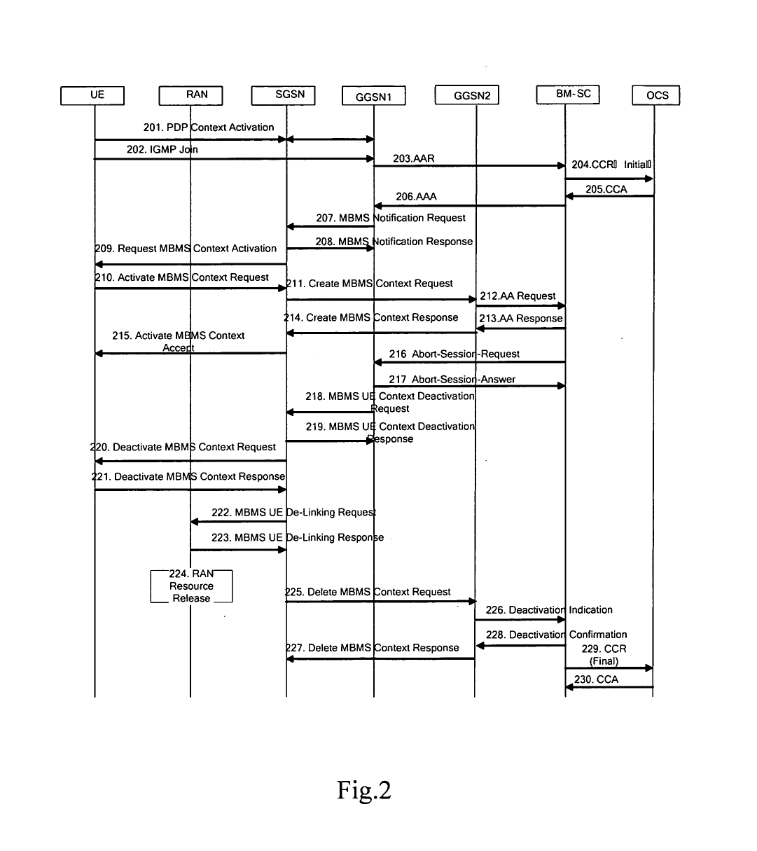

FIG. 2 illustrates a flowchart for initiating a process of terminating a user session by a BM-SC according to an embodiment of the present invention. The embodiment is implemented based on Internet Protocol version 4 (IPv4). And in the embodiment, the user equipment (UE) that originates a request for joining a multicast group is a prepaid user, the GGSN corresponding to the default Packet Data Protocol (PDP) context refers to GGSN1, and the GGSN actually providing the required MBMS service refers to GGSN2. In practical, GGSN1 and GGSN2 may be the same GGSN or different GGSNs.

Steps 201˜202: Usually when a UE needs to activate a MBMS multicast service, it should interact with the network and establish a PDP Context, including: sending a PDP Context Activation message to the network. And then, through the established PDP Context, the current UE sends a message for joining a multicast group, e.g., an IGMP join message, to GGSN1. In this message for joining a multicast group, a service type requested by a user and user ID thereof are identified by an IP multicast address.

Step 203: On receiving a message for joining a multicast group from the UE, GGSN1 sends an Authentication and Authorization Request (AAR) message to a BM-SC. The AAR message contains a user ID, session ID, and service type requested, wherein the session ID is for the UE that initiates the request for joining a multicast group.

Step 204: Once the AAR message is authenticated, the BM-SC obtains and records the session ID of the UE initiating the request for joining a multicast group from the received AAR message, acquires the user ID from the AAR message also, and confirms the subscription information of the UE based on the acquired user ID. And then, according to the UE's subscription information and service type, the BM-SC determines that the UE is a prepaid user terminal. After that, the BM-SC sends an initiated Credit Control Request (CCR) message to an Online Charging System (OCS). The CCR message contains the UE's user ID, charging information of the multicast service, and information of starting charging, e.g., Tariff Time, where the charging information of the multicast service includes a program type or a program name, and the information of starting charging is for requesting charging credit values to the OCS.

Step 205: The OCS obtains the UE's user ID from the received CCR message, and based on the instruction of the time limit of charging and the UE's user ID to determine the UE's user credit limit. The OCS, based on the UE user credit limit and the multicast service charging information, calculates the UE's allowable service value and returns the allowable service value to the BM-SC via the Credit Control Answer (CCA) message. The allowable service value is used as a condition for terminating a user session.

The service value may be the amount of the MSKs sent to the UE by the BM-SC, or the duration by which the BM-SC sends the multicast data.

Step 206: the BM-SC stores the allowable service value received, and sends back an Authentication and Authorization Answer (AAA) message to GGSN1. That is a response message of successful authentication in the exemplary embodiment of the invention.

Steps 207˜210: GGSN1 sends an MBMS Notification request to an SGSN. The SGSN sends an MBMS Notification response back to GGSN1. The response also includes a reason value which indicates whether the MBMS UE context is successfully activated. The SGSN sends the UE a Request MBMS Context Activation message. The message is for requesting the UB to activate an MBMS UB context. After establishing an MBMS UE context, the UE sends an Activate MBMS Context request to the SGSN which is for confirming the GGSN that can actually provide the required MBMS service. The GGSN confirmed is denoted as GGSN2 in the exemplary embodiment of the invention.

Steps 211˜215: The SGSN establishes an MBMS UE context, and sends a Create MBMS Context request to GGSN2 which is the GGSN that can actually provide the required MBMS service. GGNS2 sends an MBMS AA Request to the BM-SC, seeking the authorization for the UE. The authorization result is provided in an MBMS AA Response from the BM-SC. GGSN2 creates an MBMS UE context and sends a Create MBMS Context Response to the SGSN. The SGSN sends to the UE an Activate MBMS Context Accept message including the MBMS bearing capacity.

At this time, the BM-SC starts the multicast service.

Step 216: During the process of sending the multicast data, the BM-SC monitors the service value for each UE receiving the multicast data, and determines if its current service value is equal to or more than the allowable service value, i.e. if the termination condition is met. If so, the BM-SC terminates the UE's current user session, including: sending to GGSN1 a request for terminating a user session, i.e., an Abort-Session-Request message, which contains the session ID used by the UE that meets the termination condition to direct GGSN1 to terminate the corresponding session. Otherwise, the BM-SC continues transmitting the multicast data.

If the service value is the amount of the MSKs sent by the BM-SC to the UE, the termination condition is that the current amount of the MSKs sent to the UE is equal to or more than the obtained maximum amount of the MSKs that the BM-SC could send to the UE, and the process of determining whether the UE's current service value is equal to or more than the allowable service value is as follows: determining whether the current amount of the MSKs sent to the UE is equal to or more than the obtained maximum amount of the MSKs. If so, the BM-SC sends GGSN1 a request for terminating that user session.

If the service value is the duration of sending multicast data, the termination condition is that the obtained maximum duration of sending multicast data has expired, and the process of determining whether the UE's current service value is equal to or more than the allowable service value is as follows: determining if the duration of sending multicast data has expired.

Since the duration of sending multicast data to the UE is related to the amount of the MSKs send to the UE, if the service value is the amount of the MSKs sent by the BM-SC to the UE, the acquired allowable service value may be the maximum duration of sending multicast data. Here, the termination condition is that the current amount of the MSKs sent to the UE is equal to or more than the maximum amount of the MSKs converted from the obtained maximum duration of sending multicast data, so the process of determining whether the UE's current service value is equal to or more than the allowable service value is as follows: the BM-SC first calculating the maximum amount of the MSKs that can be sent based on the obtained maximum duration of sending multicast data, and then, determining whether the current amount of the MSKs sent to the UE has already been equal to the calculated maximum amount of the MSKs.

If the termination condition is satisfied, the BM-SC stops sending MSKs to the UE. Thus, the UE will no longer be able to obtain an MSK to decrypt the received multicast data, which effectively terminates the user session of that UE.

Step 217: After receiving the request for terminating a user session, GGSN1 finds the corresponding user session, based on the session ID included in the request, releases the resources corresponding to the user session, and sends back the BM-SC a response of the request for terminating a user session.

The request for terminating a user session and the response thereof in the above Step 216 and Step 217 can be carried by, respectively, messages of Abort-Session-Request (ASR) and Abort-Session-Answer (ASA), or a Re-Auth-Request (RAR) and Re-Auth-Answer (RAA), or a Session-Termination-Request (STR) and Session-Termination-Answer (STA).

Steps 218˜224: GGSN1 sends the SGSN an NMMS UE Context Deactivation Request for the UE that satisfies the termination condition. The request contains the UE's user ID. After sending back an MBMS UE Context Deactivation Response to GGSN1, the SGSN also sends an MBMS Context Deactivation Request to the UE. After deactivating the MBMS UE context, the UE sends back an MBMS Context Deactivation Response to the SGSN. The SGSN sends an MBMS UE De-Linking Request to the Radio Access Network (RAN) the UE belongs to. The request contains the UE's user ID. After releasing the resources occupied by the UB, the RAN sends back an MBMS UE De-Linking Response to the SGSN.

Steps 225˜228: The SGSN sends GGSN2 a Delete MBMS Context Request. After receiving the request, GGSN2 sends a Deactivation Indication to the BM-SC. Upon confirming that the MBMS context has been deactivated, the BM-SC sends back a Deactivation Confirmation to GGSN2, and GGSN2 returns a Delete MBMS Context Response to the SGSN.

After the network releases the resources occupied by the UB, the BM-SC no longer send an MSK to the UE so as to terminate the UE's user session. If, at this stage, the BM-SC receives a message from the UE requesting an updated MSK, since the BM-SC can't find the UE's session ID, it will refuse sending an MSK to the UE. If the BM-SC further determines there is no UB in the current network receiving the multicast data, i.e., the UE whose user session has just been terminated is the last UB using the multicast service, the BM-SC will stop transmitting the multicast data to save network resources.

Steps 229˜230: The BM-SC sends a final Credit Control Request (CCR) message to the Online Charging System (OCS). The CCR message contains the UE's id, the multicast service charging information, and the information of terminating charging which indicates to finish charging. The multicast service charging information includes a program type or a program name. On confirming finishing charging and conducting a real time billing for the UE, the OCS sends a Credit Control Answer (CCA) message back to the BM-SC.

Therefore, the network is able to initiate a termination of a user session for a single UE, and further accomplish real time charging.

In addition, another method for the network to initiate a termination of a user session for a single UE is as follows. After receiving a message from a UE for joining a multicast group, the BM-SC records the user ID and the time limit for subscribed multicast service. And then, the time limit of the multicast service is used in determining whether the UE's termination condition could be satisfied, wherein the time limit of the multicast service may be configured in the BM-SC when the service is generated, or obtained from the OCS, or acquired from other network entities based on identities of the current user and service. While sending the multicast data, the BM-SC determines whether the time limit of the UE has expired, i.e., whether the termination condition is met. If so, the BM-SC sends a request for terminating a user session to the GGSN. The request contains the UE's session ID. After receiving the request, the GGSN releases the resources occupied by the UE corresponding to the session ID, and sends back to the BM-SC a response of the request for terminating a user session. Otherwise, the BM-SC continues transmitting the multicast data. Of course, the time limit of the multicast service can be the maximum duration of sending multicast data, or the maximum amount of the MSKs sent to the UE converted from a duration of sending multicast data. Similarly, when the BM-SC determines that the current network has no more user terminal receiving the multicast data, it will stop sending the multicast data. The request for terminating a user session and the response thereof can be respectively carried by messages of ASR and ASA, or RAR and RAA, or STR and STA.

Another method for the network to initiate a termination of a user session for a single UE is as follows. In the process of a BM-SC sending multicast data, when the BM-SC receives a message for requesting to terminate the UE's user session including a particular UE's session ID from an Online Command System in an Operation Support System (OSS), the BM-SC sends a request for terminating a user session to the GGSN, including the UE's session ID. After receiving the request, the GGSN releases the resources occupied by the UE corresponding to the session ID, and sends back a response of the request for terminating a user session to the BM-SC. Therefore, the network is able to initiate a user session's termination for a particular UE. In this method, having received a message for requesting to terminate a user session of a single UE from the OSS is a termination condition. The procedure of determining if the termination condition is met is that determine whether it has received a message for requesting to terminate a user session for a UE from the OSS. Similarly after the BM-SC confirms that there is no more user terminals receiving the multicast data, it will stop transmitting the multicast data. The request for terminating a user session and the response thereof can also be carried respectively by messages of ASR and ASA, or RAR and RAA, or STR and STA.

The aforementioned three kinds of conditions in the determination can be used by itself alone or in any combination of two or three of them. The three conditions include: the user terminal's current service value being equal to or more than the obtained its allowable service value, the user terminal's time limit for subscribed multicast service having expired, or having received a message for requesting to terminate a user session of a single UE from the OSS, or a casual combination of the three. When multiple conditions are used together, the termination condition includes any two or three of them. And at this time, determining whether the termination condition is satisfied is as follows: deciding each condition included in the termination condition simultaneously, if any condition included in the termination condition has been satisfied, determine the whole termination condition has been met; and if no condition included in the termination condition could be satisfied, decide the whole termination condition has not been met. That is, the BM-SC may send a request for terminating a user session for a single UE as long as one condition is satisfied.

For example, the allowable service value obtained by a BM-SC from the OCS is the maximum duration of sending multicast data to the UE, and the maximum duration is 10 minutes. However, the BM-SC has obtained the UE's time limit for subscribed multicast service is 30 minutes based on the multicast service subscription information. When detecting the duration of sending multicast data to the UE is the specified time, 10 minutes, which is equal to the allowable service value, the BM-SC will send to a GGSN a request of terminating a user session for the UE including the UE's session ID, thereby implementing the network's initiating a termination of a particular user's session.

For another example, the allowable service value obtained by a BM-SC from the OCS is the maximum duration of sending multicast data to the UE, and the maximum duration is 10 minutes. When the duration of sending multicast data to UE by the BM-SC is 3 minutes, the BM-SC receives a message for requesting to terminate a particular UE's user session from the OSS. In this case, the BM-SC will immediately send a request for terminating the UE's user session to the GGSN so that the network can initiate a termination of a particular UE's user session.

Based on the method in accordance with the present invention, this invention also provides a multicast service device, the device includes: a unit for determining session termination conditions and a unit for initiating session termination.

The unit for determining session termination conditions is for determining whether a user terminal has satisfied its termination condition for a user session, and if the termination condition for a user session has been satisfied, outputting an instruction of session termination to the unit for initiating session termination; and the unit for initiating session termination is for initiating a request for termination a user session including a session ID when receiving the instruction of session termination so that the device that receives the request for termination a user session is able to terminate the corresponding user session to the request and release the resources of the corresponding user terminal.

In order to implement dynamic configuration of termination conditions for user sessions, the multicast service device may further include a configuration unit which is for receiving configuration information, for each user terminal, generating a termination condition for a user session, and configuring a termination condition for a user session to the unit for determining session termination conditions. So that, each user terminal's termination condition for a user session can be set dynamically according to practical circumstances. Here the multicast service device usually refers to a BM-SC.

In accordance with the present invention, a device for terminating user sessions is also provided, comprising: a unit for receiving requests and a unit for terminating sessions.

The unit for receiving requests is for receiving a request for terminating a user session which includes a session ID, and outputting an instruction containing the session ID to the unit for terminating sessions; and The unit for terminating sessions is for receiving the instruction from the unit for receiving requests, and releasing the occupied network resources corresponding to the session ID contained in the instruction. The device terminating user sessions is usually denoted as a GGSN.

The above-said multicast service device and device for terminating user sessions, and user terminals may construct a multicast service system. In this multicast service system, the multicast service device is for constructing a user session with each user terminal and transmitting multicast data to the user terminal; and for each user terminal, the multicast service device is further for determining whether the user terminal has satisfied its termination condition for a user session, and if the termination condition for a user session has been satisfied, sending a request for terminating a user session to the device for terminating user sessions which contains a session ID; and the device for terminating user sessions is for receiving the request for terminating a user session from the multicast service device, and releasing the occupied network resources corresponding to the session ID contained in the request.

In summary, the aforementioned examples are only the preferred embodiments of the invention which do not limit the scope of the present invention.

1. A method for terminating a user session in a multicast service, comprising:
initiating a request for terminating a user session by a multicast service device, the request containing a session ID for identifying the user session to be terminated, and
releasing the network resources occupied by the user session corresponding to the session ID contained in the request.

2. The method as claimed in claim 1, wherein before initiating the request for terminating a user session, the method further comprises:
for each user terminal, obtaining a termination condition for terminating the user terminal's user session, determining whether the termination condition is met, and if yes, initiating the request for terminating a user session.

3. The method as claimed in claim 2, wherein the termination condition is that the current service value is equal to or more than the allowable service value.

4. The method as claimed in claim 3, wherein obtaining of the allowable service value comprises:
on receiving a message for joining a multicast group from the user terminal, obtaining a user ID from the received message and recording;
confirming the user terminal is a prepaid subscriber based on the obtained user ID, and acquiring the allowable service value of the user terminal from an Online Charging System (OCS).

5. The method as claimed in claim 4, wherein acquiring the allowable service value of the user terminal from an Online Charging System comprises:
sending a Credit Control Request (CCR) message to the Online Charging System by the multicast service device, where the CCR message contains the user ID and multicast service charging information;
the Online Charging System determining the credit value limit of the user terminal based on the user ID, calculating the allowable service value based on the credit value limit and the multicast service charging information, and transmitting the allowable service value to the multicast service device.

6. The method as claimed in claim 5, wherein the multicast service charging information is a program type or a program name.

7. The method as claimed in claim 3, wherein if the service value is the amount of the Multicast Service Keys (MSKs) sent to the user terminal, the termination condition is that the current amount of the MSKs sent to the user terminal is equal to or more than the maximum amount of the MSKs that could be sent to the user terminal; and
if the service value is the duration of transmitting multicast data to the user terminal, the termination condition is that the current duration of transmitting multicast data to the user terminal is equal to or more than the maximum duration of transmitting multicast data to the user terminal.

8. The method as claimed in claim 7, wherein if the service value is the amount of the MSKs sent to the user terminal and the allowable service value is the maximum duration of transmitting multicast data to the user terminal, the termination condition is that the current amount of the MSKs sent to the user terminal is equal to or more than the maximum amount of the MSKs converted from the maximum duration of transmitting multicast data to the user terminal.

9. The method as claimed in claim 2, wherein the termination condition is that the user terminal's time limit for subscribed multicast service has expired.

10. The method as claimed in claim 9, wherein the termination condition that the user terminal's time limit for subscribed multicast service has expired comprises: the amount of the MSKs sent to the user terminal is equal to or more than the maximum amount of the MSKs sent to the user terminal converted from the time limit for subscribed multicast service.

11. The method as claimed in claim 9, wherein the time limit for subscribed multicast service by the user terminal is obtained by taking the following steps:
on receiving a message for joining a multicast group from the user terminal, the multicast service device recording the user ID of the user terminal and the time limit for subscribed multicast service by the user terminal.

12. The method as claimed in claim 2, wherein the termination condition is that a message for requesting to terminate a user session from an online command system has been received.

13. The method as claimed in claim 2, wherein the termination condition comprises:
the current service value being equal to the allowable service value of the user terminal, the user terminal's time limit for subscribed multicast service having expired, or a message for requesting to terminate a user session of the user terminal from an Online Command System having been received; or a casual combination of the three; and
wherein determining whether the termination condition is met comprises: determining whether any condition included in the termination condition is met, if any of the conditions included in the termination condition has been satisfied, confirming the termination condition is met.

14. The method as claimed in claim 1, further comprising: sending back a response of the request for terminating a user session to the multicast service device.

15. The method as claimed in claim 14, further comprising: on receiving the response, the multicast service device determining whether there is any other user terminal of the current multicast service in the network, if yes, continuing transmitting the multicast data; otherwise, terminating the transmitting.

16. The method as claimed in claim 14, wherein the request for terminating a user session is carried by a message of Abort-Session-Request (ASR), Re-Auth-Request (RAR), or Session-Termination-Request (STR); and
accordingly, the response of the request for terminating a user session sent back to the multicast service device is carried by a message of Abort-Session-Answer (ASA), Re-Auth-Answer (RAA), or Session-Termination-Answer (STA).

17. The method as claimed in claim 1, wherein the multicast service device is denoted as a Broadcast/Multicast Service Center (BM-SC), and the device that releases the network resources is denoted as a Gateway General Package Radio Service (GPRS) Support Node (GGSN).

18. The method as claimed in claim 17, wherein releasing the network resources is denoted as a network entity releasing the network resources based on the notification from the GGSN.

19. The method as claimed in claim 18, wherein the network entity releasing the network resources is a Serving GPRS Support Node (SGSN).

20. The method as claimed in claim 1, wherein the network entity which releases the network resources is denoted as an SGSN.

21. A method for terminating a user session in multicast service, comprising:
upon receiving a multicast service request from a user terminal, setting up a multicast transmitting channel between the user terminal and a multicast service device, and obtaining an allowable service value;
sending multicast data corresponding to the multicast service request from the multicast service device to the user terminal, and obtaining a current multicast service value dynamically;
comparing the current service value with the obtained allowable service value, if the current service value is equal to or more than the allowable service value, terminating the current transmitting.

22. The method as claimed in claim 21, wherein obtaining the allowable service value comprises:
on receiving a message of joining a multicast group from the user terminal, the multicast service device obtaining a user ID from the received message and recording the user ID;
after confirming the user terminal is a prepaid subscriber based on the user ID, the multicast service device obtaining the allowable service value of the user terminal from an Online Charging System.

23. The method as claimed in claim 22, wherein the multicast service device obtaining the allowable service value of the user terminal from an Online Charging System comprises:
sending a Credit Control Request message to the Online Charging System by the multicast service device, where the CCR message contains the user ID and the multicast service charging information;
the Online Charging System determining the credit value limit of the user terminal based on the user ID, calculating the allowable service value based on the credit value limit and the multicast service charging information of the user terminal, and transmitting the allowable service value to the multicast service device,.

24. The method as claimed in claim 21, wherein if the service value is the amount of the MSKs sent to the user terminal, the allowable service value is the maximum amount of the MSKs that could be sent to the user terminal; and
if the service value is the duration of transmitting multicast data to the user terminal, the allowable service value is the maximum duration of transmitting multicast data to the user terminal.

25. The method as claimed in claim 24, wherein if the service value is the amount of the MSKs sent to the user terminal, the allowable service value is the maximum duration of transmitting multicast data to the user terminal, and
the current service value being equal to the allowable service value is that the current amount of the MSKs sent to the user terminal is equal to or more than the maximum amount of the MSKs converted from the maximum duration of transmitting multicast data to the user terminal.

26. The method as claimed in claim 21, wherein terminating the current transmitting comprises: the multicast service device initiating a request for terminating the user session of the user terminal.

27. The method as claimed in claim 26, further comprising: sending a response of the request for terminating the user session back to the multicast service device.

28. The method as claimed in claim 27, further comprising: on receiving the response of the request for terminating the user session, the multicast service device determining if there is any other user terminals of the multicast service in the network, if yes, continuing transmitting the multicast data, otherwise, terminating the transmitting.

29. The method as claimed in claim 27, wherein the request for terminating the user session is carried by a message of Abort-Session-Request, RAR, or STR; and
accordingly, the response of the request for terminating the user session, transmitted back to the multicast service device is carried by a message of Abort-Session-Answer, RAA, or STA.

30. The method as claimed in claim 21, wherein the multicast service device is denoted as a Broadcast/Multicast Service Center (BM-SC), and the device which releases the network resources is denoted as a Gateway GPRS Support Node (GGSN).

31. The method as claimed in claim 30, wherein releasing the network resources is denoted as a network entity releasing the network resources based on the notification from the GGSN.

32. The method as claimed in claim 31, wherein the network entity is a Serving GPRS Support Node (SGSN).

33. The method as claimed in claim 21, wherein the network entity which releases the network resources is denoted as an SGSN.

34. A multicast service device, comprising: a unit for determining session termination conditions and a unit for initiating session termination, wherein:
the unit for determining session termination conditions is for determining whether a user terminal has satisfied its termination condition for a user session, and if the termination condition for a user session has been satisfied, outputting an instruction of session termination to the unit for initiating session termination; and
the unit for initiating session termination is for initiating a request for terminating a user session including a session ID when receiving the instruction of session termination.

35. The device as claimed in claim 34, further comprising:
a configuration unit for receiving configuration information, for each user terminal, generating a termination condition for a user session, and configuring a termination condition for a user session to the unit for determining session termination conditions.

36. The device as claimed in claim 34, wherein the device is denoted as a BM-SC.

37. The device as claimed in claim 35, wherein the device is denoted as a BM-SC.

38. A device for terminating user sessions, comprising: a unit for receiving requests and a unit for terminating sessions, wherein:
the unit for receiving requests is for receiving a request for terminating a user session which includes a session ID, and outputting an instruction containing the session ID to the unit for terminating sessions; and
the unit for terminating sessions is for receiving the instruction from the unit for receiving requests, and releasing the occupied network resources corresponding to the session ID contained in the instruction.

39. The device as claimed in claim 38, wherein the device is denoted as a GGSN.

40. A multicast service system, comprising: a multicast service device and user terminals, wherein the multicast service device is for constructing a user session with each user terminal and transmitting multicast data to the user terminal; and further comprising: a device for terminating user sessions, wherein:
for each user terminal, the multicast service device is for determining whether the user terminal has satisfied its termination condition for a user session, and if the termination condition for a user session has been satisfied, sending a request for terminating a user session to the device for terminating user sessions which contains a session ID; and
the device for terminating user sessions is for receiving the request for terminating a user session from the multicast service device, and releasing the occupied network resources corresponding to the session ID contained in the request.

41. The system as claimed in claim 40, wherein the multicast service device is denoted as a BM-SC, and the device for terminating user sessions is denoted as a GGSN.
